(19) United States
(12) Patent Application Publication
(10) Pub. No.: US 2010/0225141 A1
(43) Pub. Date: Sep. 9, 2010

(54) STRUCTURE FOR SIDE PORTION OF VEHICLE BODY AND VEHICLE WITH THE SAME

(75) Inventor: Takeo Mori, Shizuoka (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Aichi (JP)

(21) Appl. No.: 12/738,437

(22) PCT Filed: Oct. 17, 2008
(86) PCT No.: PCT/JP2008/068874

§ 371 Date: Apr. 16, 2010

(30) Foreign Application Priority Data
Oct. 19, 2007 (JP) 2007-272864

(51) Int. Cl. B62D 25/04

(52) U.S. Cl. 296/146.6

(57) ABSTRACT

The object of the invention is to provide a structure for side portion of a vehicle body, which can suppress large deformation of a door beam (impact beam) when a side collision load is inputted to the door beam, and a vehicle provided with the structure for side portion of a vehicle body. In the invention, if a side collision load of a vehicle is inputted to the door beam, the front end portion of the door beam is supported by a front pillar portion, and an intermediate portion close to the rear end of the door beam is supported by a support convex portion of a swollen portion which is swollen forward from a center pillar portion. Therefore, the door beam is bent and deformed to the inside of the vehicle body with the front pillar portion and the support convex portion as support points, and a specific portion on a rear end portion side, which includes a rear end portion located further rearward than the support convex portion, intrudes into a receiving concave portion of the swollen portion on the vehicle body side. As a result, the bending moment in the directions opposite to each other acts on a rear end portion side and a front end portion side of the door beam with the support convex portion as a boundary, so that large deformation of the door beam is suppressed.

### TECHNICAL FIELD

The present invention relates to a structure for side portion of a vehicle body, which is suitable for a vehicle provided with a door beam which is subjected to a side collision load, and a vehicle provided with the structure for side portion of a vehicle body.

### BACKGROUND ART

For some time, there has been generally known a vehicle in which a door beam (or impact beam) which is subjected to a side collision load of a vehicle is disposed in a door along a front-and-back direction. As this kind of structure for side portion of a vehicle body of a vehicle, for example, in Patent Citation 1, there is described a structure for side portion of a vehicle body, which is provided with an impact beam disposed along a front-and-back direction at a lower portion of the inside of a door and having front and rear end portions each fixed to the door through a bracket, a load transmitting member which transmits a side collision load of a vehicle, which is inputted to the impact beam, from an intermediate portion in a front-and-rear direction of the impact beam to a cross member on a vehicle body side, and a load receiving member.

### CITATION LIST

Patent Citation 1 Japanese Unexamined Patent Publication No. 2007-22485

### SUMMARY OF INVENTION

### Technical Problem

However, in the structure for side portion of a vehicle body described in Patent Citation 1, the front and rear end portions of the impact beam face a front pillar and a center pillar, which are framework portions of a vehicle body. Therefore, when a side collision load of a vehicle is inputted to the impact beam, a large bending moment acts on the impact beam with the load transmitting member on a vehicle body side, which faces an intermediate portion in a front-and-rear direction of the impact beam, as a support point, and as a result, there is a danger that the impact beam will be largely deformed.

Therefore, the object of the present invention is to provide a structure for side portion of a vehicle body, which can suppress large deformation of a door beam (impact beam) when a side collision load is inputted to the door beam, and a vehicle provided with the structure for side portion of a vehicle body.

### Technical Solution

According to the present invention, there is provided a structure for side portion of a vehicle body, in which a door beam which is subjected to a side collision load of a vehicle is disposed in a door along a front-and-back direction, the structure for side portion of a vehicle body including: a reinforcement material which faces a portion between a front end and a rear end of the door beam is provided on a vehicle body side that is the inside of the door, wherein the reinforcement material is disposed closer to the door beam than a reinforcement member on the vehicle body side, which is disposed at a rear side of the reinforcement material.

In the structure for side portion of a vehicle body according to the present invention, the reinforcement material provided on the vehicle body side that is the inside of the door is disposed closer to the door beam than a reinforcement member disposed at a rear side of the reinforcement material. Accordingly, if a side collision load of a vehicle is inputted to the door beam, a portion between a front end and a rear end of the door beam is supported by the reinforcement material on the vehicle body side. Therefore, the portion of the door beam, which is located further on a rearward side than the reinforcement material, is bent and deformed to the inside of the vehicle body. As a result, the bending moment in the directions opposite to each other acts on the rear end side and the front end side of the door beam with a support point created by the reinforcement material as a boundary, so that large deformation of the door beam is suppressed.

Also, if the reinforcement material is fixed to a rocker portion, since strength against a force from the side can be secured, it is preferable.

Further, if the reinforcement material is fixed to a center pillar portion, since strength against a force from the outside can be further secured, it is preferable.

Also, if the reinforcement material is disposed further on a lower side than an upper end of a seating portion of a seat and further on a rear side than a front end of the seating portion of the seat when viewed from the side, since getting on and off can be smoothly performed, it is preferable.

Also, according to the present invention, there is provided a structure for side portion of a vehicle body, in which a door beam which is subjected to a side collision load of a vehicle is disposed in a door along a front-and-back direction, the structure for side portion of a vehicle body including: a support convex portion which is provided on a vehicle body side that is the inside of the door, and protrudes toward the door beam side to be able to support an intermediate portion in the front-and-back direction of the door beam; and a receiving concave portion which is provided on the vehicle body side that is the inside of the door, and is dented in a direction separating from the door beam so as to receive a specific portion which includes a specific end portion of the door beam, which is located further rearward or forward than the support convex portion, thereby allowing the specific portion to be deformed to the inside of the vehicle body.

In the structure for side portion of a vehicle body according to the present invention, if a side collision load of a vehicle is inputted to the door beam, an intermediate portion in the front-and-rear direction of the door beam is supported by the support convex portion. Therefore, the door beam is bent and deformed to the inside of the vehicle body with the support convex portion as a support point, and the specific portion which includes the specific end portion located further rearward or forward than the support convex portion intrudes into the receiving concave portion in the vehicle body side. As a result, the bending moment in the directions opposite to each other acts on the rear end portion side and the front end portion side of the door beam with the support convex portion as a boundary, so that large deformation of the door beam is suppressed.

In the structure for side portion of a vehicle body according to the present invention, if the specific portion of the door beam is a portion in the rear end portion side, which includes the rear end portion, since the support convex portion and the receiving concave portion can be provided at a place, which does not obstruct getting on and off, in front of a lower portion of the center pillar portion of the vehicle body, it is preferable.

Here, the support convex portion in the structure for side portion of a vehicle body according to the present invention can be constituted by a swollen portion which is swollen from a vehicle body framework portion such as a front pillar or a center pillar of the vehicle body, and the receiving concave portion can be constituted as a concave portion between the vehicle body framework portion and the swollen portion.

Also, according to the present invention, there is provided a structure for side portion of a vehicle body, in which a door beam which is subjected to a side collision load of a vehicle is disposed in a door along a front-and-back direction, the structure for side portion of a vehicle body including: a support material which is provided on a vehicle body side that is the inside of the door and at a portion which faces a portion between a front end and a rear end of the door beam, wherein the door beam is provided such that in a case where a force proceeding from the outside to the inside in a vehicle width direction acts on a portion of the door beam, which is located further rearward than the support material, a rear portion of the door beam is bent to the inside while the door beam is supported by the support material.

In the structure for side portion of a vehicle body according to the present invention, in a case where a force proceeding from the outside to the inside in a vehicle width direction acts on a portion of the door beam, which is located further rearward than the support material, the rear portion of the door beam is bent to the inside while the door beam is supported by the support material. As a result, the bending moment in the directions opposite to each other acts on the rear end portion side and the front end portion side of the door beam with a support point created by the support material as a boundary, so that large deformation of the door beam is suppressed.

Here, a case where a force proceeding from the outside to the inside in a vehicle width direction acts on the portion of the door beam, which is located further rearward than the support material, includes not only a case where an external force directly acts on the door beam through a door panel, but also a case where, for example, when load is inputted to the center pillar, a force from the outside of a vehicle to a passenger room side is transmitted to the door beam through a connection portion of the center pillar and the door. That is, a case where an external force is inputted to the door beam through another member connected to the door beam is also included.

Also, according to the present invention, there is provided a vehicle provided with a structure for side portion of a vehicle body, in which a door beam which is subjected to a side collision load is disposed in a door along a front-and-back direction, the structure for side portion of a vehicle body including: a reinforcement material which is provided on a vehicle body side that is the inside of the door, so as to face a portion between a front end and a rear end of the door beam, wherein the reinforcement material is disposed closer to the door beam than a reinforcement member on the vehicle body side, which is disposed at a rear side of the reinforcement material.

In the vehicle according to the present invention, the reinforcement material provided on the vehicle body side that is the inside of the door is disposed closer to the door beam than a reinforcement member disposed at a rear side of the reinforcement material. Accordingly, if a side collision load of a vehicle is inputted to the door beam, a portion between a front end and a rear end of the door beam is supported by a reinforcement material on the vehicle body side. Therefore, a portion of the door beam, which is located further on a rearward side than the reinforcement material, is bent and deformed to the inside of the vehicle body. As a result, the bending moment in the directions opposite to each other acts on the rear end portion side and the front end portion side of the door beam with a support point created by the reinforcement material as a boundary, so that large deformation of the door beam is suppressed.

### ADVANTAGEOUS EFFECTS

In the structure for side portion of a vehicle body according to the present invention and the vehicle provided with the structure for side portion of a vehicle body, if a side collision load of a vehicle is inputted to the door beam, since an intermediate portion in the front-and-rear direction of the door beam is supported by the support convex portion on the vehicle body side, the door beam is bent and deformed to the inside of the vehicle body with the support convex portion as a support point, so that the specific portion of the door beam intrudes into the receiving concave portion in the vehicle body side. As a result, the bending moment in the directions opposite to each other acts on the rear end portion side and the front end portion side of the door beam with the support convex portion as a boundary, so that large deformation of the door beam is suppressed. That is, according to the structure for side portion of a vehicle body according to the present invention and the vehicle provided with the structure for side portion of a vehicle body, large deformation of the door beam can be suppressed when a side collision load of a vehicle is inputted to the door beam.

### BRIEF DESCRIPTION OF DRAWINGS

FIG. 1 is a front view showing a structure for side portion of a vehicle body related to a first embodiment of the present invention, as viewed from the outer surface side of a front side door.

FIG. 2 is a partial cross-sectional view of the vicinity of a rear portion of the front door, taken along line II-II of FIG. 1.

FIG. 3 is a graph showing bending moment curves acting on a door beam shown in FIG. 1, in a case where a side collision load which is inputted to the door beam is regarded as an equal load.

FIG. 4 is a front view corresponding to FIG. 1, showing a structure for side portion of a vehicle body related to a second embodiment of the present invention.

FIG. 5 is a front view corresponding to FIG. 1, showing a structure for side portion of a vehicle body related to a third embodiment of the present invention.

FIG. 6 is a partial cross-sectional view of the vicinity of a rear portion of a front door, taken along line VII-VII of FIG. 5.

FIG. 7 is a schematic perspective view showing a reinforcement material provided at the structure for side portion of a vehicle body, which is shown in FIG. 5.

### EXPLANATION OF REFERENCES

1, 11: FRONT SIDE DOOR, 1A, 11A: DOOR INNER PANEL, 1B, 11B: BRACKET, 2, 12: DOOR BEAM, 2A, 12A: FRONT END PORTION, 2B, 12B: REAR END PORTION, 2C: INTERMEDIATE PORTION, 3: VEHICLE BODY, 4: FRONT PILLAR PORTION, 5, 15: CENTER PILLAR PORTION, 6: SWOLLEN PORTION, 6A: SUPPORT CONVEX PORTION, 6B: RECEIVING CONCAVE PORTION, 6C: REINFORCEMENT MEMBER, 7: SEAT FRAME, 8: SEAT SUPPORT, 9: SPACE UNDER A SEAT, 10: REINFORCEMENT MATERIAL, 10A: CENTER PILLAR FIXING PORTION, 10B: ROCKER FIXING PORTION, 10C: BEAD, 10D: INTERMEDIATE PORTION, 12C: INTERMEDIATE PORTION (PORTION BETWEEN A FRONT END AND A REAR END), 15B: REINFORCEMENT (REINFORCEMENT MEMBER), 16: ROCKER PORTION, 17: SEAT SEATING PORTION

### DESCRIPTION OF EMBODIMENTS

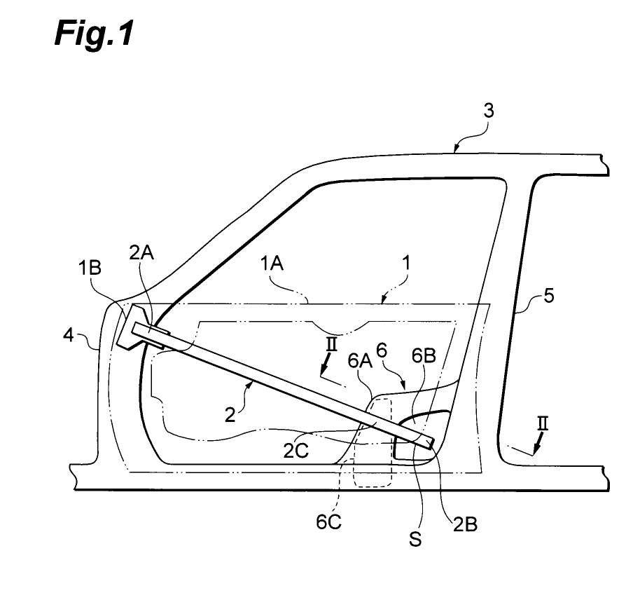

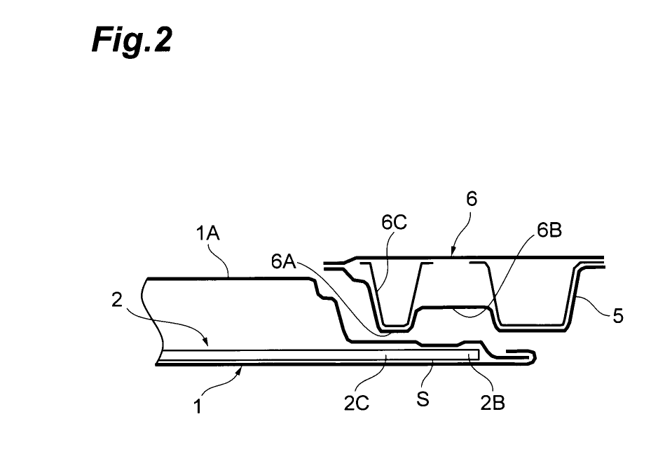

Hereinafter, best embodiments of a structure for side portion of a vehicle body according to the present invention and a vehicle provided with the structure for side portion of a vehicle body will be explained with reference to the drawings. In addition, in this explanation, the same or similar components are designated with the same reference numerals and duplicate explanation thereof is often omitted. Here, in the reference drawings, FIG. 1 is a front view showing a structure for side portion of a vehicle body related to a first embodiment, as viewed from the outer surface side of a front door, and FIG. 2 is a partial cross-sectional view of the vicinity of a rear portion of the front door, taken along line II-II of FIG. 1.

The structure for side portion of a vehicle body related to the first embodiment is, for example, a structure for side portion of a vehicle body constituted corresponding to a door beam (impact beam) 2 which is disposed in a front side door 1 as shown in FIG. 1.

The front side door 1 is made such that its front end portion is hinge-supported to be able to be opened and closed on a front pillar portion 4 of a vehicle body 3 through a pair of upper and lower door hinges (not shown) and its rear end portion is detachably locked to a center pillar portion 5 of the vehicle body 3 through a door latch (not shown).

Here, the door beam 2 is obliquely disposed from a front-side upper portion to a rear-side lower portion of the inside of the front side door 1, and a front end portion 2A thereof is strongly spot-welded to a front-side upper portion of a door inner panel 1A, which faces the front pillar portion 4 of the vehicle body, through a bracket 1B.

On the other hand, a rear end portion 2B of the door beam 2 is directly spot-welded to a rear-side lower portion of the door inner panel 1A, and the rear end portion 2B of the door beam 2 faces a direct front position of a lower portion of the center pillar portion 5 of the vehicle body.

Here, as shown in FIGS. 1 and 2, a swollen portion 6 which is continuously swollen forward from the center pillar portion is formed at a lower portion of the center pillar portion 5 of the vehicle body 3.

Then, at the swollen portion 6, a support convex portion 6A which protrudes to the door inner panel 1A side of the front side door 1 and a receiving concave portion 6B which is dented in a direction separating from the door inner panel 1A are formed.

The support convex portion 6A faces an intermediate portion 2C close to the rear end portion 2B of the door beam 2, and a reinforcement member 6C is incorporated into the inside of the support convex portion. Then, when a side collision load is inputted to the door beam 2, the support convex portion 6A can support the intermediate portion 2C close to the rear end portion 2B of the door beam 2.

Also, the receiving concave portion 6B faces a specific portion which includes a specific end portion of the door beam 2, that is, a specific portion S on the rear end portion side, which includes the rear end portion 2B of the door beam 2, which is located further rearward than the support convex portion 6A, and when a side collision load is inputted to the door beam 2, the receiving concave portion 6B receives the specific portion S which includes the rear end portion 2B of the door beam 2, so as to allow the specific portion S to be deformed to the inside of the vehicle body 3.

In the structure for side portion of a vehicle body of the first embodiment configured as described above, if another vehicle collides with the front side door 1 from the side, so that a side collision load is inputted from the front side door 1 to the door beam 2, the door beam 2 along with the front side door 1 is pressed to the vehicle body 3 side. At this time, the front end portion 2A of the door beam 2 is supported by the front pillar portion 4 of the vehicle body 3 side through the bracket 1B, and the intermediate portion 2C close to the rear end portion 2B of the door beam 2 is supported by the support convex portion 6A of the swollen portion 6 which is swollen forward from the center pillar portion 5 of the vehicle body 3 side.

Because of this, the door beam 2 is bent and deformed to the inside of the vehicle body 3 with the front pillar portion 4 and the support convex portion 6A as support points, and the specific portion S on the rear end portion side, which includes the rear end portion 2B located further rearward than the support convex portion 6A, intrudes into the receiving concave portion 6B of the swollen portion 6 on the vehicle body 3 side. As a result, the bending moment in the directions opposite to each other acts on the rear end portion side and the front end portion side of the door beam 2 with the support convex portion 6A as a boundary, so that large deformation of the door beam 2 is suppressed.

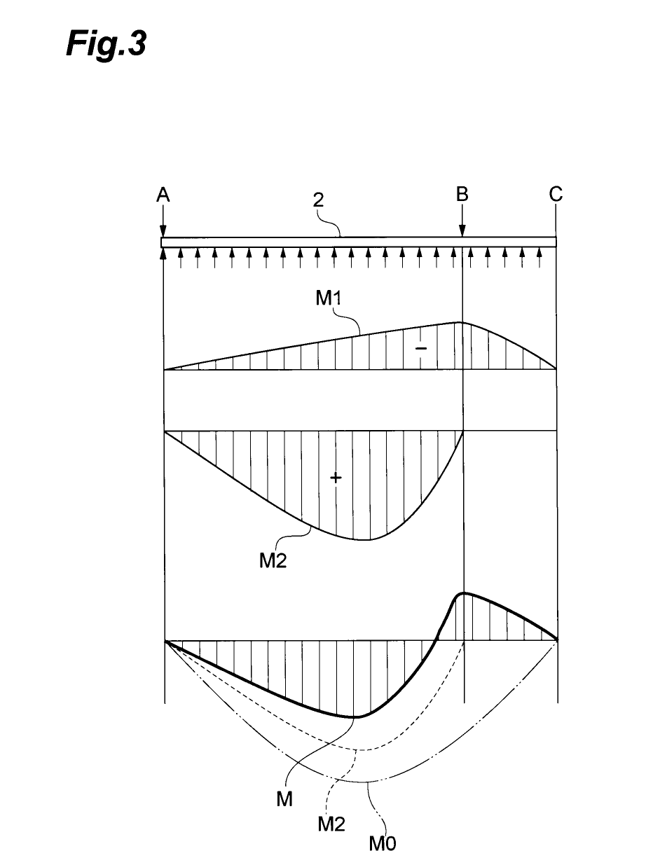

Here, FIG. 3 shows bending moment curves acting on the door beam 2 in a case where a side collision load which is inputted to the door beam 2 is regarded as an equal load. In addition, in the drawing, symbol A represents a support point of the front end portion 2A of the door beam 2 by the front pillar portion 4, symbol B represents a support point of the intermediate portion 2C of the door beam 2 by the support convex portion 6A, and symbol C represents a free end of the rear end of the door beam 2.

As shown in the curve graphs of FIG. 3, a composite bending moment M acting on the door beam 2 is represented by a thick line graph in which a bending moment M1 of a minus indication by an equal load which is inputted between the support point B and the free end C and a bending moment M2 of a plus indication by an equal load which is inputted between the support point A and the support point B are superimposed.

Here, in comparison with the bending moment M2 of a plus indication represented by a dotted line, it can be seen that the maximum value of the plus indication portion of the composite bending moment M represented by a thick line becomes lower than the maximum value of the bending moment M2 represented by a dotted line.

Also, in comparison with a bending moment acting on a hypothetical door beam in the past, in which support points exist at both ends, and which is represented by a two-dot chain line, it can be seen that the maximum value of the plus indication portion of the composite bending moment M represented by a thick line becomes drastically lower than the maximum value of the bending moment represented by a two-dot chain line.

Therefore, according to the structure for side portion of a vehicle body of the first embodiment, large deformation of the door beam 2 can be sufficiently suppressed when a side collision load of a vehicle is inputted to the door beam.

Also, in the structure for side portion of a vehicle body of the first embodiment, since the support convex portion 6A and the receiving concave portion 6B are formed at the swollen portion 6 which is swollen forward from a lower portion of the center pillar portion 5, the swollen portion 6 does not obstruct getting on and off.

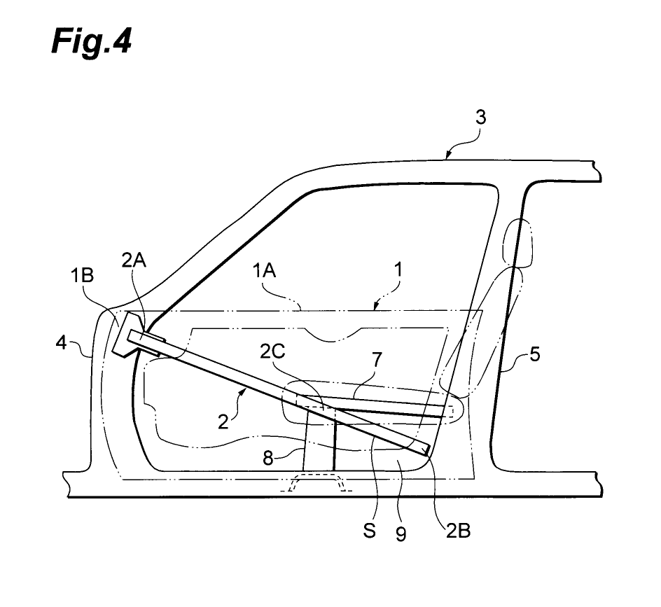

The structure for side portion of a vehicle body according to the present invention is not to be limited to the first embodiment described above. For example, the support convex portion 6A of the swollen portion 6 shown in FIG. 1 can be substituted by an upper end portion of a seat support 8 which supports a seat frame 7 of the vehicle body 3 side (a second embodiment), as shown in FIG. 4. In this case, the receiving concave portion 6B of the swollen portion 6 shown in FIG. 1 can be substituted by a space 9 under a seat, which is formed below the seat frame 7 and behind the seat support 8.

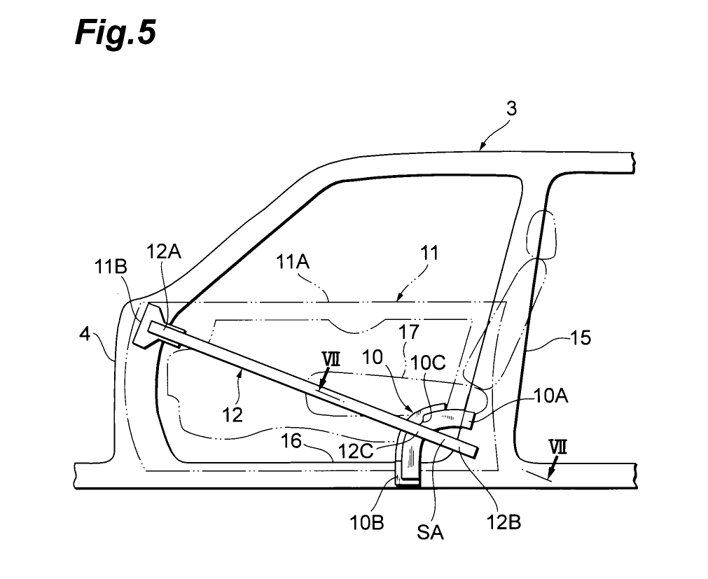

Also, as shown in FIG. 5, a structure in which a reinforcement material 10 is provided on the vehicle body 3 side may also be adopted (a third embodiment). Also, a vehicle related to this embodiment is a vehicle provided with a structure for side portion of a vehicle body, which will be described later. The reinforcement material 10 has at both ends thereof a center pillar fixing portion 10A and a rocker fixing portion 10B. Also, the center pillar fixing portion 10A and the rocker fixing portion 10B are respectively fixed to a center pillar portion 15 and a rocker portion 16 by spot-welding, so that the reinforcement material 10 is fixed to the outside of the vehicle body 3. Further, the reinforcement material 10 faces an intermediate portion 12C which is a portion between a front end and a rear end of a door beam 12 at an intermediate portion between the center pillar fixing portion 10A and the rocker fixing portion 10B. In addition, the door beam 12 is mounted on a front side door 11, similarly to the first embodiment. However, the door beam 12 is different from that of the first embodiment in that a rear end portion 12B is disposed so as to face a lower end portion of the center pillar portion 15.

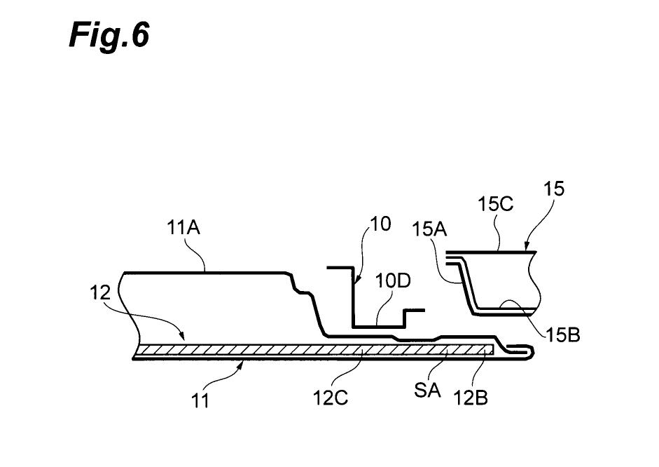

FIG. 6 is a partial cross-sectional view of the vicinity of a rear portion of the front door 11, taken along line VII-VII of FIG. 5. As shown in FIG. 6, the reinforcement material 10 is provided on the vehicle body 3 side in proximity to a door inner panel 11A of the front side door 11. Also, the center pillar portion 15 which is disposed on the rear side of the reinforcement material 10 has a center pillar outer panel 15A which is a surface portion, reinforcement 15B, and a center pillar inner panel 15C. The reinforcement 15B is to function as a reinforcement member and is incorporated into the inside of the center pillar portion 15. A specific portion SA on the rear end side, which includes the rear end portion 12B of the door beam 12, faces the center pillar portion 15 and a gap portion between the center pillar portion 15 and the reinforcement material 10.

In addition, in this embodiment, the reinforcement material 10 has an intermediate portion 10D which is disposed closer to the door beam 12 than the reinforcement 15B. That is, the reinforcement material 10 is disposed closer to the door beam 12 than the reinforcement member 15B on the vehicle body side, which is disposed on the rear side of the reinforcement material 10. In other words, the reinforcement material 10 protrudes in a vehicle width direction further than the reinforcement 15B of a portion which faces the rear end portion 12B of the door beam 12. This is because the portion of the center pillar portion 15, to which the center pillar fixing portion 10A of the reinforcement material 10 is fixed, protrudes in a vehicle width direction further than a lower end portion of the center pillar portion, which faces the rear end portion 12B of the door beam 12.

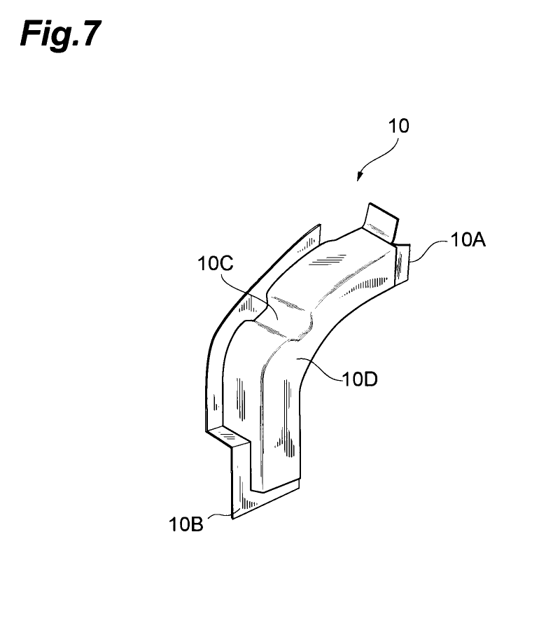

Also, as shown in FIG. 7, the reinforcement material 10 has a face extending in a vehicle width direction, and also has a bead 10C, which is formed in a vehicle width direction, in the vicinity of an intermediate curved portion of the face. Accordingly, reduction in weight of the reinforcement material 10 is achieved, and sufficient strength is also secured.

In the structure for side portion of a vehicle body configured as described above, the same operation and effect as those of the first and second embodiments are obtained. That is, if a side collision load is inputted from a side portion of the vehicle body 3 to the door beam 12, the intermediate portion 12C of the door beam 12 is supported by the intermediate portion 10D of the reinforcement material 10 which is the nearest reinforcement member. Therefore, in the door beam 12, the specific portion SA on the rear end portion side, which includes the rear end portion 12B located further rearward than the reinforcement material 10, is bent and deformed to the inside of the vehicle body 3. As a result, the bending moment in the directions opposite to each other acts on the rear end portion side and the front end portion side of the door beam with the support point 10D created by the reinforcement material 10 as a boundary, so that large deformation of the door beam 12 is suppressed.

Also, as described above, since the reinforcement material 10 is strongly fixed to the center pillar portion 15 and the rocker portion 16, strength against a force from the side is secured.

Also, as shown in FIG. 5, since the reinforcement material 10 is disposed further on a lower side than an upper end of a seat seating portion 17 and further on a rear side than a front end of the seat seating portion 17 when viewed from the side, getting on and off can be smoothly performed.

In the third embodiment described above, a case is shown where the reinforcement material 10 is fixed to the center pillar portion 15 and the rocker portion 16. However, the reinforcement material 10 may also be fixed to any one of the center pillar portion 15 and the rocker portion 16. Also, in the third embodiment, as a reinforcement member on the vehicle body 3 side, which is disposed on the rear side of the reinforcement material 10, the reinforcement 15B is illustrated. However, even in a case where other reinforcement member is provided on the vehicle body 3 side, it is enough if the reinforcement material 10 is the closest to the door beam 12.

In addition, the reinforcement member in the present invention indicates a member constituting a framework with high rigidity and is distinguished from a member with relatively low rigidity, which is provided for design purposes. For example, the reinforcement 15B in the third embodiment corresponds to a reinforcement member, and the center pillar outer panel 15A corresponds to a member for design purposes.

In the third embodiment described above, a case is described where the reinforcement material 10 which faces a portion between the front end and the rear end of the door beam is provided. However, in the structure for side portion of a vehicle body according to the present invention, in place of the reinforcement material 10, a support material may also be provided. The support material is provided at a portion which faces a portion between the front end and the rear end of the door beam. The door beam is provided such that in a case where a force proceeding from the outside to the inside in a vehicle width direction acts on a portion located further rearward than the support material, the rear portion of the door beam is bent to the inside while the door beam is supported by the support material.

According to such a configuration, in a case where a force proceeding from the outside to the inside in a vehicle width direction acts on the portion of the door beam, which is located further rearward than the support material, the rear portion of the door beam is bent to the inside while the door beam is supported by the support material. As a result, the bending moment in the directions opposite to each other acts on the rear end portion side and the front end portion side of the door beam with a support point created by the support material as a boundary, so that large deformation of the door beam is suppressed.

### INDUSTRIAL APPLICABILITY

According to the structure for side portion of a vehicle body according to the present invention and the vehicle according to the present invention, which is provided with the structure for side portion of a vehicle body, large deformation of the door beam can be suppressed when a side collision load of a vehicle is inputted to the door beam.

1. A structure for side portion of a vehicle body, in which a door beam which is subjected to a side collision load of a vehicle is disposed in a door along a front-and-back direction, the structure for side portion of a vehicle body comprising:
a reinforcement material which is provided on a vehicle body side that is the inside of the door, so as to face a portion between a front end and a rear end of the door beam, the reinforcement material being connected to a center pillar portion,
wherein the reinforcement material is disposed closer to the door beam than a reinforcement member on the vehicle body side, which is disposed at a rear side of the reinforcement material.

2. The structure for side portion of a vehicle body according to claim 1, wherein the reinforcement material is fixed to a rocker portion.

3. The structure for side portion of a vehicle body according to claim 1, wherein the reinforcement material is fixed to the center pillar portion.

4. The structure for side portion of a vehicle body according to claim 1, wherein the reinforcement material is disposed further on a lower side than an upper end of a seating portion of a seat and further on a rear side than a front end of the seating portion of the seat when viewed from the side.

5. A structure for side portion of a vehicle body, in which a door beam which is subjected to a side collision load of a vehicle is disposed in a door along a front-and-back direction, the structure for side portion of a vehicle body comprising:
a support convex portion which is provided on a vehicle body side that is the inside of the door, and protrudes toward the door beam side to be able to support an intermediate portion in the front-and-back direction of the door beam; and
a receiving concave portion which is provided on the vehicle body side that is the inside of the door, and is dented in a direction separating from the door beam so as to receive a specific portion which includes a specific end portion of the door beam, which is located further rearward or forward than the support convex portion, thereby allowing the specific portion to be deformed to the inside of the vehicle body.

6. The structure for side portion of a vehicle body according to claim 5, wherein the specific portion of the door beam is a portion on a rear end portion side, which includes a rear end portion.

7. The structure for side portion of a vehicle body according to claim 5, wherein the support convex portion and the receiving concave portion are formed at a swollen portion which is swollen from a vehicle body framework portion.

8. The structure for side portion of a vehicle body according to claim 5, wherein the door beam is obliquely disposed from a front-side upper portion to a rear-side lower portion of a front side door, and the support convex portion and the receiving concave portion are formed at a swollen portion which is swollen forward from a lower portion of a center pillar of the vehicle body.

9. A structure for side portion of a vehicle body, in which a door beam which is subjected to a side collision load of a vehicle is disposed in a door along a front-and-back direction, the structure for side portion of a vehicle body comprising:
a support material which is provided on a vehicle body side that is the inside of the door and at a portion which faces a portion between a front end and a rear end of the door beam,
wherein the door beam is provided such that in a case where a force proceeding from the outside to the inside in a vehicle width direction acts on a portion of the door beam, which is located further rearward than the support material, a rear portion of the door beam is bent to the inside while the door beam is supported by the support material.

10. A vehicle provided with a structure for side portion of a vehicle body, in which a door beam which is subjected to a side collision load is disposed in a door along a front-and-back direction, the structure for side portion of a vehicle body comprising:
a reinforcement material which is provided on a vehicle body side that is the inside of the door, so as to face a portion between a front end and a rear end of the door beam,
wherein the reinforcement material is disposed closer to the door beam than a reinforcement member on the vehicle body side, which is disposed at a rear side of the reinforcement material.
